(19) United States
(12) Patent Application Publication
(10) Pub. No.: US 2012/0304810 A1
(43) Pub. Date: Dec. 6, 2012

(54) FLEXIBLE BICYCLE CRANK

(76) Inventors: Christopher Butterfield, Broomfield, CO (US); Spencer Curtis, Fort Collins, CO (US); Jonathan Tollerud, Camberwell (AU)

(21) Appl. No.: 13/310,555

(22) Filed: Dec. 2, 2011

Related U.S. Application Data
(60) Provisional application No. 61/419,361, filed on Dec. 3, 2010.

(51) Int. Cl. B62M 3/00

(52) U.S. Cl. 74/594.1

(57) ABSTRACT

Spindles and cranks for bicycles are disclosed herein. An embodiment of a spindle comprises a first spindle portion comprising a first end and a second end. The first end is substantially opposite the second end, wherein a first bicycle crank arm is attachable to the first end. A second spindle portion comprises a first end and a second end. The first end is substantially opposite the second end, wherein a second bicycle crank arm is attachable to the first end. A spring device is connected between the first spindle portion and the second spindle portion. The first spindle portion second end is located proximate the second spindle portion second end.

This application claims priority from U.S. provisional application 61/419,361 filed on Dec. 3, 2010 for FLEXIBLE BICYCLE CRANK of Butterfield, which is incorporated by reference for all that is disclosed therein.

### BACKGROUND

Bicycle cranks are rigid structures that connect to the pedals and front sprockets or chain rings of bicycles. The chain rings and crank are rotatable about an axis. As the rider of a bicycle turns the crank via the pedals, the crank and, thus, the chain ring, rotate about the axis. A chain attached between the chain ring and the rear wheel serves to move the bicycle.

Some bicycle riders use bicycles in activities that cause extreme impact on the bicycles and the riders. For example, some riders use bicycles to jump. Others use bicycles for trail riding, which may include jumping between and off ledges and rocks. Such applications cause substantial impact to the riders and the bicycles. In addition, some of these riders need to obtain as much lift as possible from the bicycles as they jump from one location to another.

### BRIEF DESCRIPTION OF THE DRAWINGS

FIG. 1 is a side elevation view of an embodiment of a bicycle having a flexible crank.

FIG. 2 is a front elevation view of an embodiment of the crank of FIG. 1.

FIG. 3 is a side elevation view of the crank of FIG. 2 showing an embodiment of the displacement of the pedals.

FIG. 4 is a cut away view of an embodiment of the coupler of FIGS. 2 and 3.

FIG. 5 is a cut away view of another embodiment of the coupler.

FIG. 6 is a cut away view of a lower bracket of a bicycle having a flexible spindle located therein.

FIG. 7 is a cut away view of the spindle of FIG. 6 wherein an elastic material rather than a spring joins the spindle portions.

FIG. 8 is a side cut away view of another embodiment of a crank and a spindle.

FIG. 9 is an isometric view of an embodiment of a crank with a spring affixed thereto.

FIG. 10 is an isometric view of an embodiment of the collar of FIG. 9.

FIG. 11 is a plan view of an embodiment of the spring of FIG. 9.

### DETAILED DESCRIPTION

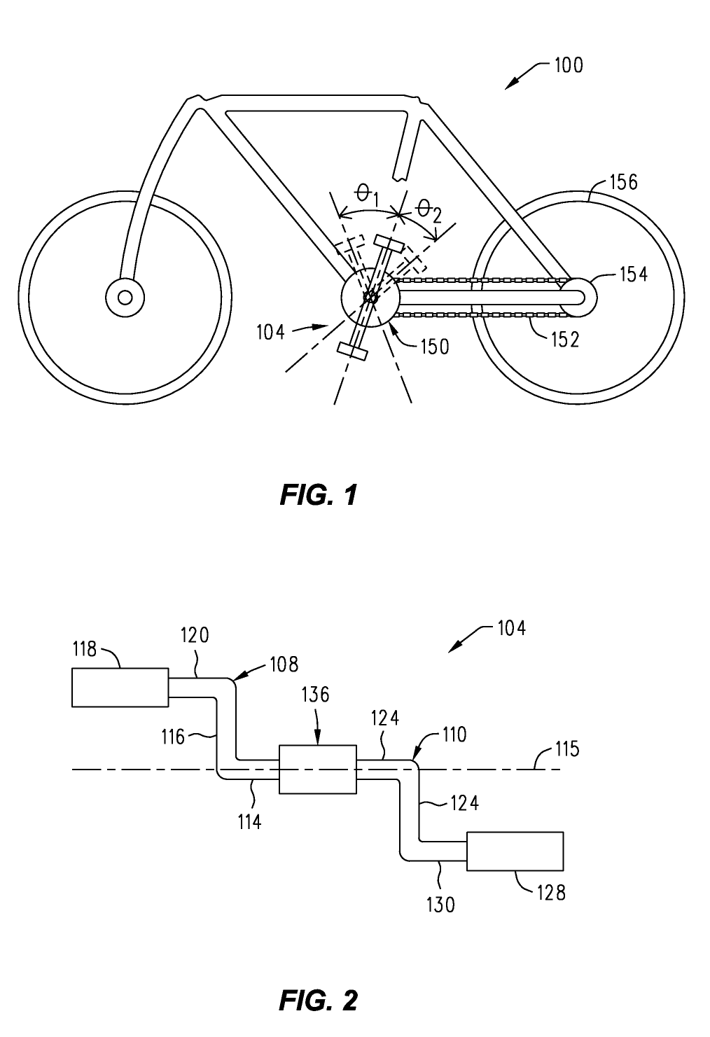

An embodiment of a bicycle 100 having a flexible crank 104 is shown in FIG. 1. A detailed elevation view of the crank 104 is shown in FIG. 2. The crank 104 has two separate portions, a first crank portion 108 and a second crank portion 110 that are movable relative to each other. It is noted that the crank 104 is described as being flexible. Flexible means that the pedals are not rigidly fixed to one another and one pedal may move independent of the other pedal as described in greater detail below. It is noted that in some embodiments, a spindle, described further below, to which crank arms or portions attach, may be flexible.

The first crank portion 108 includes a first spindle portion 114 that is connected or connectable to a first crank arm 116. The first crank arm 116 may extend substantially perpendicular to the first spindle portion 114. The first crank arm 116 may be attachable to the first spindle portion 114 or they may be formed as a single unit. The first spindle portion 114 is rotatable about an axis 115. A first pedal 118 is attached to the first crank arm 116. In some embodiments, a first pedal member 120 may connect the first pedal 118 to the first crank arm 116. It is noted that the first pedal 118 and the first pedal member 120 may be provided by the user of the crank 104 and may not be part of the crank 104.

The second crank portion 110 may be substantially similar to the first crank portion 108. The second crank portion 110 includes a second spindle portion 124 that is connected or connectable to a second crank arm 126 and may extend substantially perpendicular to the second spindle portion 124. The second spindle portion 124 may also be rotatable about the axis 115. A second pedal 128 is attached to the second crank arm 126. A second pedal member 130 may connect the second pedal 128 to the second crank arm 126. As with the first crank portion 108, the second pedal 128 and the second pedal member 130 may not necessarily be parts of the crank 104. It is noted that the second spindle portion 124 may be attachable to the second crank arm 126 or they may be formed as a single unit.

It is noted that the flexing of the crank may be achieved within the spindle portions 114, 124 as described in greater detail below. Accordingly, a user may obtain the spindle portions 114, 124 and attached specific crank arms and pedals. The combination will yield a flexible crank.

The first spindle portion 114 and the second spindle portion 124 are coupled together via a coupler 136. It is noted that the coupler 136 may be a separate unit or it may be integrally formed with either the first spindle portion 114 or the second spindle portion 124. When the first spindle portion 114 and the second spindle portion 124 are connected, they are sometimes referred to as a single spindle. The coupler 136 enables the first crank portion 108 to move relative to the second crank portion 110 about the axis 115. More specifically, the first spindle portion 114 and the second spindle portion 124 are rotatable relative to each other about the axis 115. A spring, spring mechanism, spring material, or the like is connected between the first crank portion 108 and the second crank portion 110. The spring serves to retain the first crank arm 116 oriented in an opposite direction relative to the second crank arm 126 when no substantial forces are applied to the pedals 118, 128. This may be referred to as equilibrium and the orientation of the pedals may be the same orientation as pedals on a conventional bicycle crank.

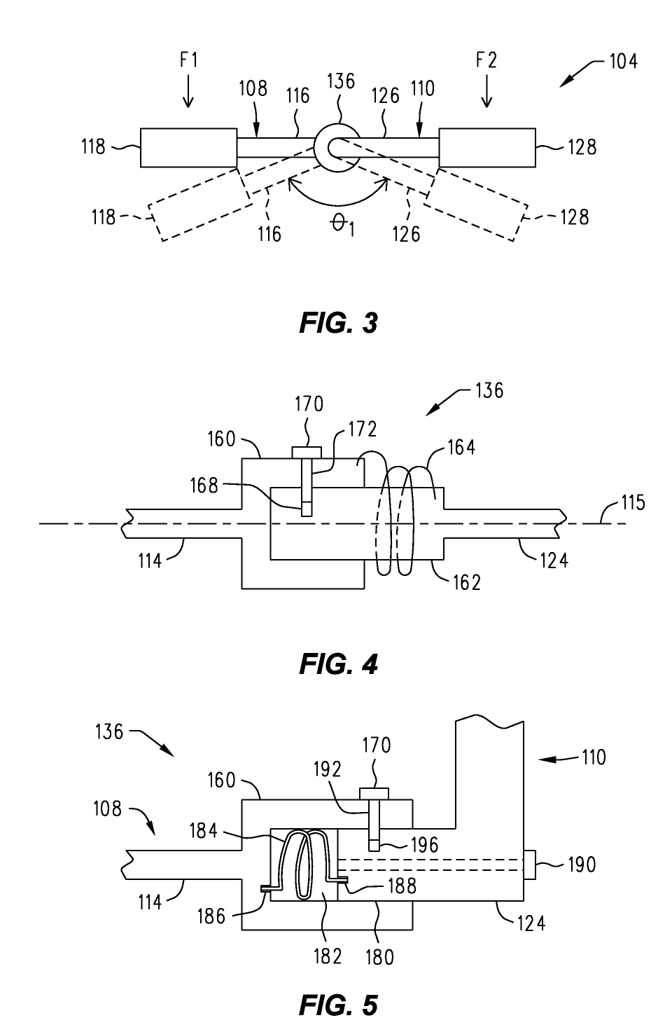

As described above, the spring serves to force the first crank arm 116 and the second crank arm 126 to equilibrium, which may be where they are oriented in opposite directions. With additional reference to FIG. 3, which is a side elevation view of the crank 104, the crank arms 116, 126 may be oriented in different directions. The orientation of the first crank arm 116 to the second crank arm 126 may be at approximately one hundred eighty degrees as shown by the solid line in FIG. 3. This orientation may exist when the bicycle is used in normal operation, such as riding on a paved surface or when normal force is applied to the pedals 118, 128. The normal force is a force used in normal riding, such as normal acceleration and when the bicycle is used on good road conditions.

When a force greater than a predetermined value is applied to either or both pedals 118, 128, the spring connecting the first crank portion 108 and the second crank portion 110 flexes, which causes the crank portions 108, 110 to move relative to each other. More specifically, when the force applied to the pedals 118, 128 exceeds a predetermined spring force, the crank portions 108, 110 may move relative to each other. An example of the crank portions 108, 110 moving relative to each other is shown by the dashed lines in FIG. 3. The movement of the crank portions 108, 110 relative to each other is sometimes referred to as flexing. As the crank flexes, the angle between the first crank arm 116 and the second crank arm 126 reduces to θ1. In order for the crank arms 116, 126 to flex to the angle θ1, a force F1 is applied to the first pedal 118 and a second force F2 is applied to the second pedal 128. When the sum of the forces F1, F2 is greater than a predetermined value, the resulting torque on the above-described spring causes the crank arms 116, 118 to flex as shown by the dashed lines in FIG. 3.

The forces F1 and F2 may be generated by different means. For example, the rider of the bicycle 100 may land from a jump. If the rider stands on the pedals 118, 128 during the landing, the forces F1 and F2 are generated and may be great enough to cause the first crank 108 to move or flex relative to the second crank 110. The force may also be generated if the rider uses the bicycle on a bumpy road.

It is noted that the crank 104 is connected to a chain ring 150, FIG. 1, as is common with most bicycles. The chain ring 150 turns a chain 152 that is connected to a rear sprocket 154. The rear sprocket 154 connects to the rear wheel 156 of the bicycle 100 in a conventional manner. A rider may apply a substantial force to a single pedal when riding the bicycle 100. For example, when riding up a hill or accelerating, a substantial force may be applied to the leading pedal and virtually no force may be applied to the trailing pedal. The rider may or may not want the crank portions 108, 110 to flex relative to each other during this type of pedaling. The flexing may be controlled by an adjustable spring or selecting a spring with a suitable spring constant so as to only allow flexing when a force greater than a preselected amount is applied to the leading pedals 118, 128.

When the crank arms 116, 126 are flexed as shown by the dashed lines of FIG. 3, energy is transferred to the spring. The release of the energy in the spring will cause the crank arms 116, 126 to return to their equilibrium state or they may temporarily flex to a position opposite the dashed lines in FIG. 3. The rider may use the energy in the spring to launch himself and/or the bicycle 100. For example if a rider is hopping from one location to another, the initial impact will cause energy to be stored in the spring. As the energy is released and the crank arms 116, 126 are returned to their equilibrium state, the rider may be launched. More specifically, if the rider's feet are on the pedals as they are returned to the equilibrium state, the rider will be launched. By using the launch, the rider may propel himself and the bicycle 100 to the next location.

Having described the operation of the crank 104, the coupling of the first crank portion 108 to the second crank portion 110 will now be described. As described above, the first crank portion 108 and the second crank portion 110 have to rotate about the axis 115 and flex relative to each other.

An example of a coupler 136 that enables such rotation is shown in FIG. 4, which is a side cut away view of an embodiment of the coupler 136. The coupler 136 of FIG. 4 has a cup 160 that is connected to the first spindle portion 114 or integrally formed with the first spindle portion 114. The cup 160 is sized to receive a shaft 162 that is connected to the second spindle 124, wherein the shaft 162 is rotatable within the cup 160. It is noted that the shaft 162 and the second spindle 124 may be a single unit. A spring 164 is connected between the cup 160 and the shaft 162. The spring 164 is shown in FIG. 4 as being a torsion spring, however, it could be any type of spring that performs the spring functions described herein. For example, the spring 164 could be a spiral spring or an elastic material. The spring constant of the spring 164 establishes the amount of force required to cause the cup 160 to move relative to the shaft 162, which is related to the force required to move one pedal relative to the other pedal. In some embodiments, the spring 164 is not preloaded. If it is preloaded, the cup 160 would move relative to the shaft 162 in one direction easier than it would move in the opposite direction.

In order to prevent the spring 164 from exceeding its elastic limit, the amount of rotation between the cup 160 and the shaft 162 may be limited. In the embodiment of FIG. 4, the shaft 162 has a slot 168 formed therein. The cup 160 has a hole 172 aligned with the slot 168. A pin 170 passes through the hole 172 and extends into the slot 168. The length of the slot 168 limits the extent to which the cup 160 is able to move relative to the shaft 162. Accordingly, the length of the slot 168 limits the movement of the first crank portion 114 relative to the second crank portion 124.

Another embodiment of the coupler 136 is shown in FIG. 5. The coupler 136 of FIG. 5 has a cup 160 and a shaft 180. The shaft 180 may be integral to the second spindle 124 and may be substantially similar to the shaft 162 except that it does not extend fully into the cup 160. As shown in FIG. 5, a gap 182 exists between the shaft 180 and the cup 160. The gap 182 serves to hold a spring 184 that provides the above-described flexing between the crank portions 108, 110.

The spring 184 is connected between the cup 160 and the shaft 180. It is noted that the spring 184 needs to be connected between the first crank portion 108 and the second crank portion 110. In the embodiment of FIG. 5, the cup 160 has a recess 186 that receives an end of the spring 184. It is noted that other mechanisms can be used to secure the spring 184 to the cup 160. The shaft 180 also has a mechanism to secure the other side of the spring 184 to the shaft 180. In the embodiment of FIG. 5, a screw 190 passes through the shaft 180 and is used to secure the spring 184 to the shaft 180. The use of the screw 190, or other similar fastener, enables the spring 184 to be secured to the shaft 180 during manufacture of the coupler 136. In other embodiments, the shaft 180 may have a recess 188 like the recess 186 in the cup 160 to receive the spring 184.

The cup 160 and shaft 180 may have mechanisms to keep them from becoming separated. The mechanisms may also prevent the shaft 180 and cup 160 from rotating beyond a predetermined amount relative to each other. In the embodiment of FIG. 5, the cup 160 has a hole 192 in which a pin 194 is passed. The pin 194 extends into a slot 196 in the shaft 180. The pin 194 prevents the shaft 180 and the cup 160 from becoming separated. The length of the slot 196 also limits the amount of rotation between the cup 160 and the shaft 180. Accordingly, the length of the slot 196 also limits the amount that the first crank portion 108 can rotate relative to the second crank portion 110.

In other embodiments, the diameter of the gap 182 limits the amount that the spring 184 can unwind, which, in turn limits the movement of the pedals relative to each other in a first direction. A rod or the like may extend through the spring 184 which limits the amount in which the spring 184 can wind. Accordingly, limiting the winding limits the movement of the pedals relative to each other in a second direction opposite the first direction.

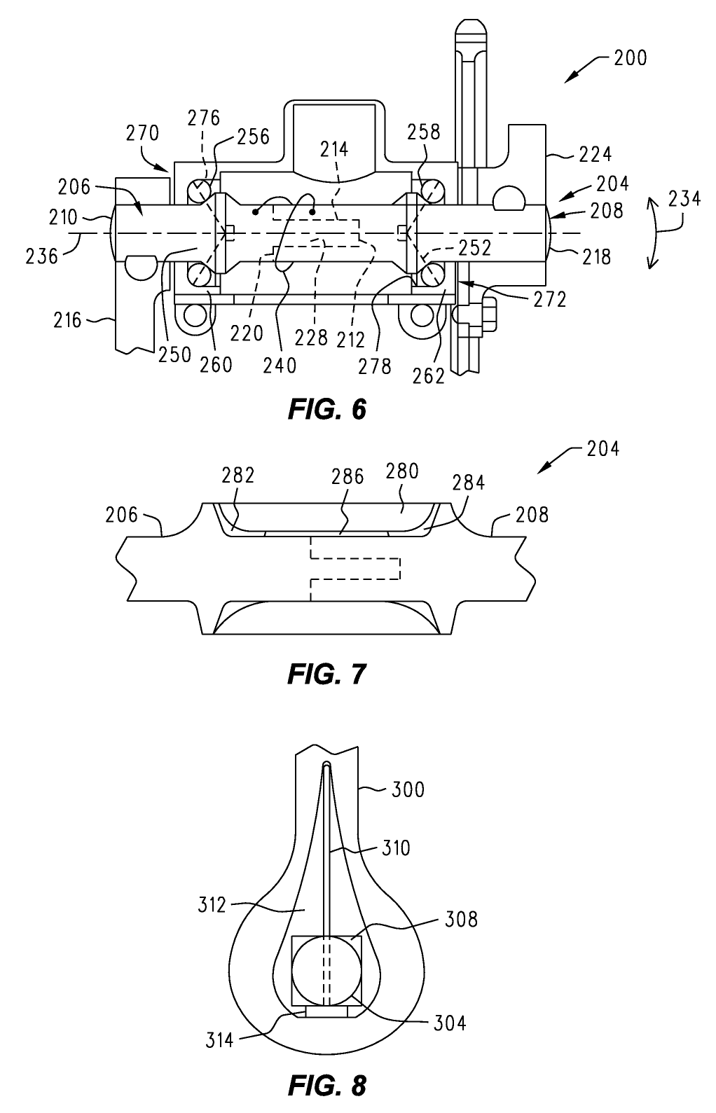

As briefly described above, many bicycles use crank assemblies that include a spindle wherein crank arms attach to the spindle. Such a configuration is shown in FIG. 6, which is a cut away view of an embodiment of a lower bracket 200 of a bicycle. It is noted that many different configurations exist for the lower bracket 200. The spindle 204 of this embodiment is a flexible spindle and includes two portions, a first spindle portion 206 and a second spindle portion 208. The spindle 204 may be a replacement for a conventional spindle so that little or no retrofitting is required to the bicycle receiving the flexible spindle 204.

The first spindle portion 206 has a first end 210 and a second end 212 located opposite the first end 210. A crank arm 216 is attachable to the first end 210. The second end 212 has an extension 214 that is receivable within the second spindle portion 208 as described below. The second spindle portion 208 has a first end 218 and a second end 220 that is located opposite the first end 218. A crank arm 224 is attachable to the first end 218. The second end 220 has a cavity 228 formed therein that is sized to receive the extension 214 of the first spindle portion 206.

The extension 214 is received into the cavity 228 to form the spindle 204. The lengths of the extension 214 and the cavity 228 serve to keep the first spindle portion 206 from moving in an arc direction as noted by arc 234 when the bicycle is in use. Rather, the spindle 204 is rotatable about an axis 236 wherein the first spindle portion 206 may rotate relative to the second spindle portion 208. However, both spindle portions 206, 208 rotate about the axis 236. It is noted that other mechanisms may provide the same function of the extension 214 and the cavity 228. For example, the extension 214 could be a screw and the cavity 228 could be tapped to receive the screw.

A spring 240 connects the first spindle portion 206 and the second spindle portion 208. The spring 240 may be substantially similar to the springs described above. For example, the spring 240 may be a tension spring. Holes may be formed into the spindle portions 206, 208 wherein the ends of the spring 240 extend into the holes. As with the previous springs, the spindle 204 may include mechanisms to prevent the spring 240 from exceeding its elastic limit. For example, the extension 214 and the cavity 228 may be keyed in order to limit the amount of movement permitted between the first spindle portion 206 and the second spindle portion 208. In other embodiments, a pin similar to the pin 170 of FIG. 4 may be used to limit the relative movement.

In another embodiment, the winding of the spring 240 around the spindle 204 will limit the amount of movement of the first spindle portion 206 relative to the second spindle 208 when they move in a first direction relative to one another. When the first spindle portion 206 moves in the opposite direction relative to the second spindle portion 208, the spring 240 unwinds. A collar, not shown, or the like may be placed around the spring 240 to limit the movement. The distance between the collar and the spring 240 will limit the amount of movement of the first spindle portion 206 relative to the second spindle portion 208.

The first spindle portion 206 and the second spindle portion 208 need to be kept together. In some embodiments, a pin or other retainer, such as a screw or nut, may be passed through the first and second spindle portions 206, 208 in order to keep them together. For example, a pin or the like may be placed along the axis 236 and extend through both the first and second spindle portions 206, 208.

In other embodiments, the structure of the lower bracket 200 in conjunction with the physical attributes of the spindle 204 may serve to keep the spindle portions 206, 208 together during use. The spindle 204 includes a first race 250 located on the first spindle portion 206 and a second race 252 located on the second spindle portion 208. As described below, the races 250, 252 are surfaces on which bearings 256, 258 set or spin. More specifically, the first bearings 256 set on the first race 250 and the second bearings 258 set on the second race 252. The lower bracket 200 has a first cup 260 that screws into a first end 270 of the lower bracket 200 and a second cup 262 that screws into a second end 272 of the lower bracket 200. The first cup 260 has a race 276 and the second cup has a race 278. The races 276, 278 serve as outer races for the bearings 256, 258.

During installation of the spindle 204, it is placed into the lower bracket 200. The bearings 256, 258 are placed onto their respective races 250, 252. The cups 260, 262 are then screwed into the lower bracket 200. The races 276, 278 in the cups 260, 262 oppose each other. Therefore, as the cups 260, 262 are screwed into the lower bracket 200, they will exert some force which will keep the first spindle portion 206 and the second spindle portion 208 together.

Another embodiment of the spindle 204 is shown in FIG. 7. Rather than using a spring to connect the first spindle portion 206 and the second spindle portion 208, an elastic material 280, such as rubber is used. The elastic material 280 is adhered to or otherwise attached to the first spindle portion 206 at a first location 282 and to the second spindle portion 208 at a second location 284. A gap 286 exists between the first location 282 and the second location 284 which allows for the spindle portions 206, 208 to flex or twist relative to each other. The elastic material 280 may be rigid enough so as not to deform or twist until a predetermined force is applied between the spindle portions 206, 208. The force required for twisting may be adjusted by lengthening or shortening the gap 286. A long gap 286 will cause the required force to be less in order to cause twisting.

When a large force is applied to the pedals, the elastic material twists or flexes to absorb the energy. The rider may use the stored energy to propel the bicycle as described above.

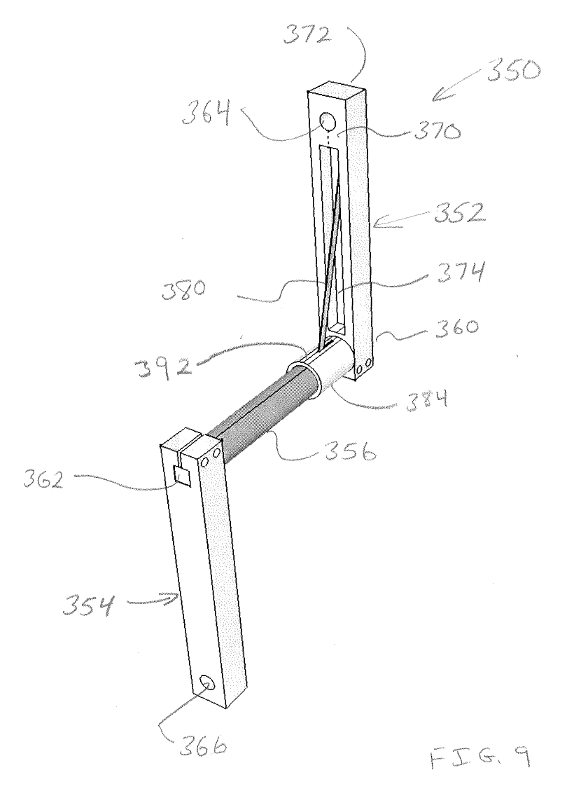

Another embodiment of the invention is shown in FIG. 8, which is a side cutaway view of an embodiment of a crank arm 300 mounted to a spindle 304. It is noted that another crank (not shown) may be mounted to the other side of the spindle 304. The spindle 304 is movable relative to the crank arm 300. In the embodiment of FIG. 8, the spindle 304 is round and fits through a round hole 308 in the crank arm 300. A spring member 310 acts between the crank arm 300 and the spindle 304. In the embodiment of FIG. 8, the spring member 310 extends through the spindle 304 and into a cavity 314 formed in the crank arm 300.

The spring member 310 has a spring constant that prevents it from flexing during normal operation of the bicycle to which the crank arm 300 and spindle 310 are attached. When a force exceeding a predetermined amount is applied to the crank arm 300, the spring member 310 flexes slightly. This flexing is very similar to the flexing described above with reference to the flexing occurring in the spindles described above. For example, if the rider of the bicycle lands from a jump or the like, the impact of the rider on the crank arm 300 may cause the spring member 310 to flex. This flexing absorbs the shock of the impact and transfers the energy into the spring member 310.

The energy stored in the spring member 310 may be released in a manner that propels the bicycle. For example, the rider and the bicycle may jump to another location or the crank arm 300 may rotate via the stored energy in the spring member 310.

It is noted that the amount of flexing between the crank arm 300 and the spindle 304 and the force required to cause this flexing may be controlled by the shape of the cavity and the material and length of the spring member 310. For example, a longer cavity 312 will enable more torque to be applied to the spring member 310, which will enable the flexing to occur with less force applied to the crank arm 300. A wider cavity 312 will enable a greater amount of flexing between the crank arm 300 and the spindle 304.

The spring member 310 of FIG. 8 has a head 314 that prevents it from passing too far into the spindle 304. Other embodiments may screw into the spindle 304 or have no head 314. The crank arm 300 may have devices other than the cavity 312 to engage the spring member 310. For example, pins or the like (not shown) may extend from the crank arm 300 in order to engage the spring member 310.

The embodiment of FIG. 8 has many advantages. It is very simple to implement by the use of a crank and spindle that are modified slightly relative to conventional cranks and spindles. In addition, the spring member 310 may be replaced very easily. Thus, a rider can change the flex characteristics by simply changing the spring member 310. It is noted that both crank arms affixed to the spindle304 may have springs associated with them.

A similar embodiment of a crank 350 is shown in FIG. 9, which is an isometric view of the crank 350. The crank 350 has a first crank arm 352 and a second crank arm 354 that are connected by a spindle 356. The spindle 356 may have races and other devices or portions to hold bearings or to otherwise work in a bicycle. The first crank arm 352 and the second crank arm 354 both have spindle mounting portions 360 and 362, respectively, that serve to attach the crank arms 352, 354 to the spindle 356. In the embodiment of FIG. 9, the second crank arm 354 is rigidly affixed to the spindle 356 and the first crank arm 352 is rotatably attached to the spindle 256. Accordingly, the first crank arm 352 may pivot or move relative to the spindle 356. Pedal mounts 364, 366 are located on the crank arms 352, 354 and serve to mount pedals to the crank arms 352, 354 in a conventional manner.

In some embodiments, the first crank arm 352 and the spindle 356 have a bearing (not shown) located therebetween. The bearing enables the first crank arm to rotate relative to the spindle 356 without causing wear on either part. In some embodiments, a fastening mechanism is used to rotatably attach the first crank arm 352 to the spindle. A bearing is associated with the fastening device in order to prevent wear on the devices.

The first crank arm 352 has an inner surface 370 and an outer surface 372, wherein the inner surface 370 faces the frame of the bicycle when the crank 350 is mounted in a bicycle. The inner surface 370 has an opening 374 formed therein. In the embodiment of FIG. 9, the opening 374 is elongated and extends substantially in the direction of the first crank arm 352. In some embodiments, the opening 374 extends to the outer surface 372 and in other embodiments, it does not. The opening 374 is configured to receive a spring 380 as described in greater detail below.

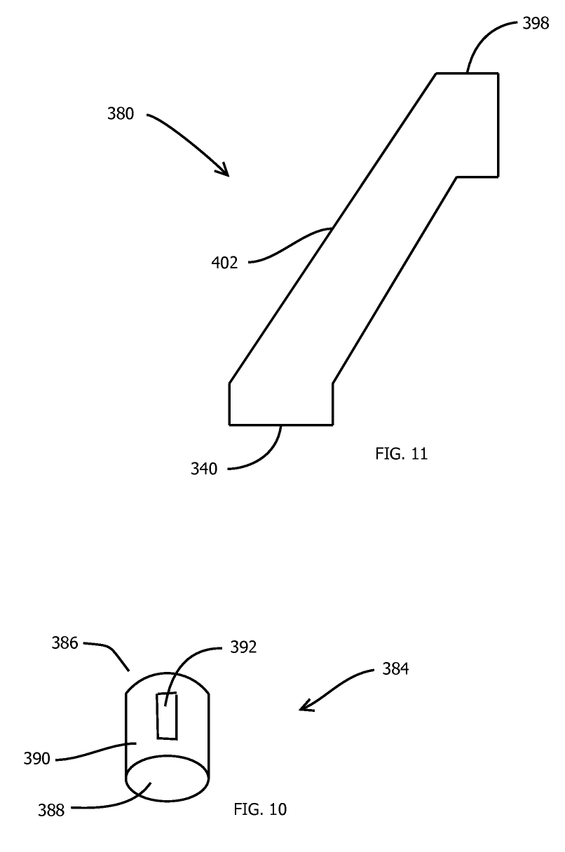

The spindle 356 also has an opening or other mechanism to receive the spring 380. In the embodiment of FIG. 9, the spindle 356 has a collar 384 that has the opening 392 located therein. An isometric view of the collar 384 is shown in FIG. 10. The collar 384 has a first end 386 and a second end 388. A sleeve 390 extends between the first end 384 and the second end 386. The opening 392 is located in the sleeve 390, wherein the spring 380 passes through the opening 392. The opening 392 has a width, which may be wider than the width of the spring 380 as described in greater detail below.

In some embodiments, the collar 384 is affixed to the first crank arm 352 as shown in FIG. 9. The collar 384 and the first crank arm 352 may both be rotatable relative to the spindle 356, which enables the crank arms 352, 354 to move or flex relative to each other as described in greater detail below. The spindle 356 may have an opening beneath the opening 392 in the collar wherein the spring 380 is receivable in the opening.

An embodiment of the spring 380 is shown in FIG. 11, which is a plan view of the spring 380. The spring has a first tab 398, a second tab 400, and a flexible portion 402. It is noted that in some embodiments, the whole spring, including the tabs 398, 400 are flexible. The first tab 398 is configured to be received in the opening 374. In some embodiments, the first tab 398 is secured into the opening 374 by way of a fastening device, such as a screw. The second tab 400 is configured to pass through the opening 392 in the collar 384 and into the above-described opening in the spindle 356. As with the first tab 398, the second tab 400 may be secured to the spindle 356 as described below.

The spring 380 may be made of a spring material that is capable of withstanding the force applied by an adult rider and return to its original shape. In some embodiments, the spring 380 is fabricated from a material that is a metal material that flexes when subjected to the above-described forces. In other embodiments, the spring 380 is fabricated from a composite material that is able to flex or otherwise store energy when subjected to the above-described forces.

In use, the rider applies a force between the crank arms 352, 354, which results in the force being applied to the spring 380 and causes the crank arms 352, 354 to move in opposite directions. The movement of the crank arms 352, 354 relative to each other causes energy to be stored in the spring 380. The width of the opening 392 determines the amount that the first crank arm 352 is able to move relative to the second crank arm 354. More specifically, when the first crank arm 352 moves to a point relative to the second crank arm 354 where the second tab 400 of the spring 380 contacts a side of the opening 392, the first crank arm 352 is prevented from moving any further relative to the second crank arm 354. The spring 380 stores the energy accumulated from the flexing and releases it to force the crank arms 352, 354 back to their original positions. This release of energy by the spring 380 helps propel a rider.

The spring 380 may have virtually any shape, wherein the shape is a design choice. As described above, the tabs 398, 400 may be fabricated from a flexible material as with the flexible portion 402. In some embodiments, the tabs 398, 400 are reinforced and may not flex to the extent of the flexible portion 402. In some embodiments, the reinforcing is provided by covering the tabs 398, 400 with a material that is stronger than the flexible portion 402. For example, if the spring 380 is made of a composite material, the tabs 398, 402 may be encased with a hard metal. The hard metal prevents the tabs from crushing or otherwise becoming deformed when subjected to the forces applied by the crank arms 352, 354. In other embodiments, the tabs 398, 400 are fabricated with a material that will not compress or otherwise deform when subjected to the forces applied by the crank arms 352, 354.

The spring 380 has been described as being affixed to the first crank arm 352. In other embodiments, a second spring may be connected between the spindle 356 and the second crank arm 354.

A washer or other friction reducing device may be located proximate the second end 388 of the collar 384. The washer serves to reduce friction between the collar 384 and other mechanisms in the bicycle.

The collar may have at least one hole extending therethrough that is suitable for receiving a screw or other fastening device. At least one similar hole may be formed in the spindle 356 to receive the fastening device. The fastening device may contact the spring 380 to secure the spring 380 within the spindle 356. The hole in the collar 384 is larger than the hole in the spindle 356 in order to enable rotation of the collar 384, and thus the first crank arm 352, relative to the spindle 356. In addition, the fastening device serves to limit the rotation of the collar 384 relative to the spindle 356. Therefore, should the spring 380 fail, the first crank arm 352 will only rotate a predetermined distance relative to the second crank arm 354.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A bicycle crank comprising:
a first crank portion having a first spindle portion, said first crank portion being rotatable about an axis;
a second crank portion having a second spindle portion, said second spindle portion being rotatable about said axis;
a spring device connecting said first crank portion to said second crank portion;
wherein said first spindle portion is moveable relative to said second spindle portion about said axis.

2. The bicycle crank of claim 1, wherein said spring device is an elastic material.

3. The bicycle crank of claim 2, wherein said elastic material comprises rubber.

4. The bicycle crank of claim 1, wherein the movement of said first spindle portion relative to said second spindle portion about said axis is limited to a predetermined arc.

5. The bicycle crank of claim 1, wherein said first spindle portion has an end that comprises a cavity and said second spindle portion has an end that is receivable in said cavity; said cavity and said second spindle portion end being rotatable about said axis.

6. The bicycle crank of claim 5, wherein said spring device is located within said cavity.

7. The bicycle crank of claim 6, wherein said spring device is windable and wherein the amount that it is able to be unwound is limited by the diameter of said cavity.

8. The bicycle crank of claim 5, wherein said spring device is a wound spring and further comprising a member that extends at least partially through said spring device, said member limiting the amount that said spring device can wind.

9. A spindle for a bicycle, said spindle comprising:
a first spindle portion comprising a first end and a second end, said first end being substantially opposite said second end, wherein a first bicycle crank arm is attachable to said first end;
a second spindle portion comprising a first end and a second end, said first end being substantially opposite said second end, wherein a second bicycle crank arm is attachable to said first end; and
a spring device connected between said first spindle portion and said second spindle portion;
said first spindle portion second end being located proximate said second spindle portion second end.

10. The spindle of claim 9 wherein:
an axis extends between said first spindle portion first end and second end, said first spindle portion being rotatable about said axis;
said axis further extending between said second spindle portion first end and second end, said second spindle portion being rotatable about said axis.

11. The spindle of claim 9, wherein said first spindle portion is rotatable relative to said second spindle portion and wherein the amount of rotation between said first spindle portion and said second spindle portion is limited to a preselected arc.

12. The spindle of claim 11, wherein said first spindle portion second end has an opening sized to receive said second spindle portion second end.

13. The spindle of claim 12, wherein said spring device is located within said opening.

14. The spindle of claim 13, wherein said spring device is windable and further comprising a member associated with said spring device, said member limiting the amount that said spring device can wind.

15. The spindle of claim 9, wherein said spring device comprises an elastic material.

16. The spindle of claim 9, wherein said spring device is a torsion spring.

17. A bicycle crank comprising:
a crank arm, said crank arm comprising an opening wherein a first end of a spring is receivable in said opening;
a spindle that is movably mounted to said crank arm, said spindle comprising an opening to receive a second end of said spring.

18. The bicycle crank of claim 17, and further comprising a collar attached to said crank arm and extending over said spindle, said collar comprising an opening proximate said opening in said spindle, wherein said second end of said spring is receivable in said opening of said collar.

19. The bicycle crank of claim 18, wherein said opening in said collar has a width that is greater than the width of said second end of said spring, said width enabling said crank arm to rotate a predetermined amount relative to said spindle.

20. The bicycle crank of claim 17, wherein said spring comprises a composite material.
